(19) United States
(12) Patent Application Publication
(10) Pub. No.: US 2026/0187842 A1
(43) Pub. Date: Jul. 2, 2026

(54) Sensor Calibration

(71) Applicant: Supernal, LLC, Washington, DC (US)

(72) Inventors: Elena Ramona Stefanescu, Washington, DC (US); Matthew Phillip Aralis, Washington, DC (US)

(21) Appl. No.: 19/129,376

(22) PCT Filed: Nov. 15, 2023
(86) PCT No.: PCT/US2023/079874

§ 371 Date: May 13, 2025

Related U.S. Application Data
(60) Provisional application No. 63/383,786, filed on Nov. 15, 2022.

(51) Int. Cl. G06T 7/80; G06T 7/70; G06V 20/17; G06V 20/56

(52) U.S. Cl. CPC G06T 7/80; G06T 7/70; G06V 20/17; G06V 20/56; G06T 2207/30252

(57) ABSTRACT

A method includes capturing a first measurement of one or more first features of an environment using a first sensor that is attached to a vehicle and capturing a second measurement of one or more second features of the environment using a second sensor that is attached to the vehicle. The method also includes determining a set of parameters including one or more of (a) first intrinsic parameters of the first sensor, (b) second intrinsic parameters of the second sensor, or (c) a transform between the first sensor and the second sensor, using the first measurement, the second measurement, first locations of the one or more first features within the environment, and second locations of the one or more second features within the environment. The method also includes selecting an action based on the set of parameters and performing the action.

### CROSS-REFERENCE TO RELATED APPLICATION

This application claims priority to U.S. Provisional Ser. No. 63/383,786, filed Nov. 15, 2022, the contents of which are hereby incorporated by reference.

### FIELD OF THE DISCLOSURE

The present disclosure relates to systems, methods, and devices for calibrating a sensor or detecting an environment. In particular, the disclosure relates to determining calibration parameters of one or more sensors attached to a vehicle.

### BACKGROUND

Cameras or other sensors that are attached to vehicles can be used for navigation and/or collision avoidance. Extrinsic parameters and intrinsic parameters of a sensor generally must be known so that features of the vehicle's environment captured by the sensor can be mapped to a position relative to the vehicle. Initial values for the extrinsic parameters and intrinsic parameters are typically determined when the vehicle is manufactured or periodically thereafter when serviced. However, events like hard landings, thermal expansion or contraction, or mechanical modifications that occur between periodic maintenance may unintentionally change the extrinsic parameters or the intrinsic parameters of the sensor.

The takeoff and landing of an aircraft are often the most critical and accident-prone portion of its mission. In piloted craft (and particularly piloted craft intended to carry passengers), significant time and resources are required to train a pilot for takeoff and landing. Among other reasons, these issues make it desirable to have an autonomous capable Urban Air Mobility (UAM) vehicle that is capable of taking off and landing without the need for pilot operation or intervention. Indeed, it is expected that the navigation and guidance services for UAM operations will use a combination of currently available and new technologies to guide aircraft from takeoff through landing. Sensors with complimentary modalities and error characteristics will be deployed to improve navigation accuracy. Such sensors may include, for example, cameras in the visible and IR spectrum, radar, 2D/3D LiDAR, sonars, inertial sensors, etc. The calibration of each of these sensors can be decomposed into internal calibration parameters and external parameters. The external calibration parameters can include the position and orientation of the sensor relative to near vertiport or at the vertiport level objects coordinate system such as fiducial markers, buildings, etc., or other sensors on-board of the aircraft. The internal parameters, such as the calibration matrix of a sensor, can affect how the sensor samples the scene. How the sensor samples the scene can include what information the sensor analyzes first or what information the sensor determines first.

Generally, intrinsic and/or extrinsic parameters can be determined using sensors such as cameras to sense or take images of a known calibration pattern such as a checkerboard or fiducial markings. Using known correspondences between points or features of the calibration pattern, the extrinsic parameters can be found.

At present, events such as hard landings, turbulence or perturbations, temperature changes, humidity, or electrical shock may require recalibration of the sensors or cameras. Known prior calibration systems for sensors rely on a dedicated calibration environment. For example, known prior calibration systems use known environments while the sensors or cameras are in a predetermined position and orientation.

As flying craft depend more and more on autonomous systems that rely on calibrated instruments, it is increasingly important to maintain precise instrument calibration at every stage of a flight. And, for urban aircraft, used for example as transport, precise instrument calibration is critical to moving efficiently and ensuring safety of passengers and/or persons and possessions on the ground. Landing, for example, involves movement of at least the flying craft as it relates to a landing pad or area in a precise way that must be controlled for safety and aircraft longevity.

Thus, it is desirable for a calibration system to perform target-free calibration when usual calibration techniques are unavailable, such as in-flight or at the vertiport level, after a sensor becomes uncalibrated and thus inaccurate and unreliable.

### SUMMARY

A first example is a method comprising capturing a first measurement of one or more first features of an environment using a first sensor that is attached to a vehicle; capturing a second measurement of one or more second features of the environment using a second sensor that is attached to the vehicle; determining a set of parameters comprising one or more of (a) first intrinsic parameters of the first sensor, (b) second intrinsic parameters of the second sensor, or (c) a transform between the first sensor and the second sensor, using the first measurement, the second measurement, first locations of the one or more first features within the environment, and second locations of the one or more second features within the environment; selecting an action based on the set of parameters; and performing the action.

A second example is a non-transitory computer readable medium storing instructions that, when executed by one or more processors of a vehicle, cause the vehicle to perform the method of the first example.

A third example is a vehicle comprising: a first sensor; a second sensor; one or more processors; and a computer readable medium storing instructions that, when executed by the one or more processors, cause the vehicle to perform the method of the first example.

A fourth example is a method comprising: determining a first frame of reference for a first sensor based on an object sensed by the first sensor; determining a second frame of reference for a second sensor based on the object sensed by the second sensor; determining a transform between the first frame of reference and the second frame of reference; and determining a calibration transform of the first sensor based on the transform.

A fifth example is a non-transitory computer readable medium storing instructions that, when executed by one or more processors of a calibration system, cause the calibration system to perform the method of the fourth example.

A sixth example is a calibration system comprising: one or more processors; a first sensor attached to the vehicle; a second sensor attached to the vehicle; and a non-transitory computer readable medium storing instructions that, when executed by the one or more processors, cause the calibration system to perform the method of the fourth example.

A seventh example is a method comprising: determining a first frame of reference for a first sensor based on an object sensed by the first sensor; determining a second frame of reference for a second sensor based on the object sensed by the second sensor; determining a transform between the first frame of reference and the second frame of reference; and determining a calibration transform of the first sensor based on the transform.

An eighth example is a non-transitory computer readable medium storing instructions that, when executed by one or more processors of a calibration system, cause the calibration system to perform the method of the seventh example.

A ninth example is a calibration system comprising: one or more processors; a first sensor attached to the vehicle; a second sensor attached to the vehicle; and a non-transitory computer readable medium storing instructions that, when executed by the one or more processors, cause the calibration system to perform the method of the seventh example.

A tenth example is a method comprising: receiving a geometric location of a calibration object; receiving sensor information of the calibration object from a first sensor or a second sensor; determining if the sensor information can be compared to a stored sensor information based on one or more comparison factors including availability or quality; and thereafter determining a frame of reference of the calibration object based on the comparison.

An eleventh example is a non-transitory computer readable medium storing instructions that, when executed by one or more processors of a calibration system, cause the calibration system to perform the method of the tenth example.

A twelfth example is a calibration system comprising: one or more processors; a first sensor attached to the vehicle; a second sensor attached to the vehicle; and a non-transitory computer readable medium storing instructions that, when executed by the one or more processors cause the calibration system to perform the method of the tenth example.

### BRIEF DESCRIPTION OF THE DRAWINGS

The accompanying drawings, which are incorporated in an constitute part of this specification, illustrate multiple embodiments of the presently disclosed subject matter and, together with this description, serve to explain the principles of the presently disclosed subject matter; and, furthermore are not intended in any manner to limit the scope of the presently disclosed subject matter.

FIG. 1 is a block diagram of a vehicle, in accordance with exemplary embodiment of the present invention.

FIG. 2 is a flow chart of functionality of a vehicle that operates within an environment, in accordance with exemplary embodiment of the present invention.

FIG. 3 is a schematic diagram of functionality of a vehicle that operates within an environment, in accordance with exemplary embodiment of the present invention.

FIG. 4 is a block diagram of a method, in accordance with exemplary embodiment of the present invention.

FIG. 5 shows an exemplary system for a calibration of a sensor, in accordance with exemplary embodiment of the present invention.

FIG. 6 shows an exemplary method of sensor calibration, in accordance with exemplary embodiment of the present invention.

FIG. 7 shows an exemplary method of environment detection, in accordance with exemplary embodiment of the present invention.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

As noted above, more reliable methods of calibrating sensors so that they may be used to accurately determine proximity to features (e.g., objects) within an environment are needed. Accordingly, a method of the disclosure includes capturing a first measurement of one or more first features of an environment using a first sensor that is attached to a vehicle (e.g., an aerial vehicle). Such features could include a landing pad or a vertiport, a fiducial maker on or near the landing pad or the vertiport, a landmark, a tree, or a building, for example. The method also includes capturing a second measurement of one or more second features of the environment using a second sensor that is attached to the vehicle. The one or more first features can be distinct from the one or more second features or can include one or more features that are included in the one or more second features. The first sensor and the second sensor can have overlapping fields of view, or alternatively can have non-overlapping fields of view. A feature may be recognized as a point cloud captured by a sensor that resembles a reference point cloud representing the feature. Depending on the type of sensor in use, features may be recognized in many different ways. Generally, the first measurement and the second measurement are captured simultaneously. The method also includes determining a set of parameters comprising one or more of (a) first intrinsic parameters of the first sensor, (b) second intrinsic parameters of the second sensor, or (c) a transform between the first sensor and the second sensor, using the first measurement, the second measurement, known first locations of the one or more first features within the environment, and known second locations of the one or more second features within the environment. Extrinsic parameters define rotational and translational transforms that relate the pose of the sensor to an external reference coordinate system such as latitude and longitude. Intrinsic parameters define how the three-dimensional environment captured by the sensor is mapped to the two dimensional pixel array of the sensor. Intrinsic parameters are generally represented by a matrix of rank and dimensions that vary based on the type of sensor being used. The method also includes selecting an action based on the set of parameters and performing the action. In some examples, the action may include using actuators of the vehicle to avoid or move closer to a particular object.

In certain situations, the known extrinsic parameters of the first sensor may be considered more reliable when compared to the second sensor. For example, the vehicle may have absorbed an impact (e.g., a bird strike) closer to the second sensor than the first sensor. In this situation, the vehicle can use the distances between the one or more first features and the first sensor exhibited by the first measurements, the distances between the one or more second features and the second sensor exhibited by the second measurements, the known locations (e.g., longitude, latitude, and altitude) of the one or more first features and the one or more second features, and the known intrinsic parameters of the first sensor and the second sensor to determine the transform between the first sensor and the second sensor. The vehicle may use this transform to accurately relate measurements captured by the second sensor to a correct reference frame.

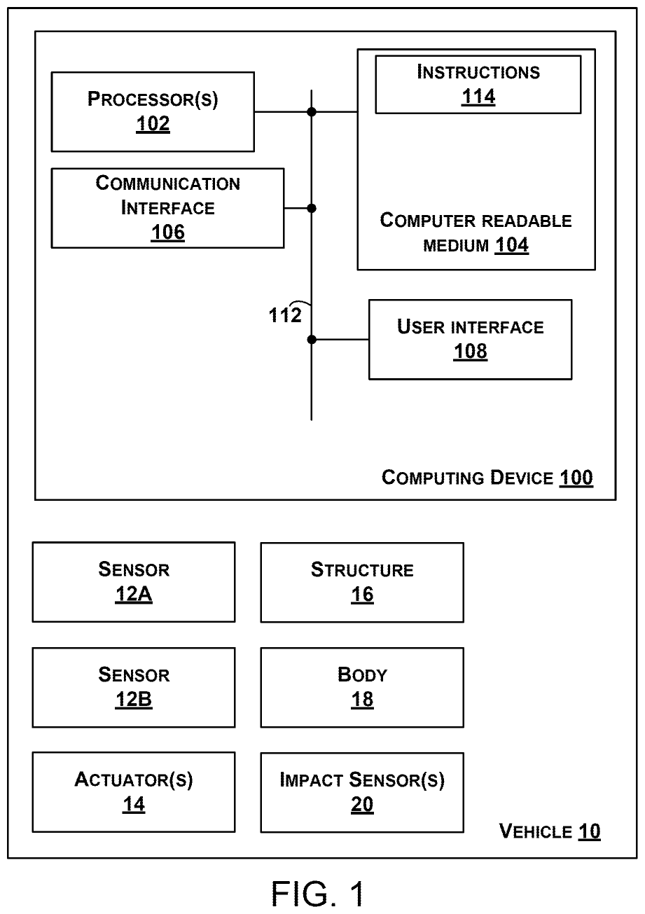

FIG. 1 is a block diagram of a vehicle 10, in accordance with exemplary embodiments of the present invention. The vehicle 10 may include a computing device 100, a sensor 12A, a sensor 12B, actuator(s) 14, a structure 16, a body 18, and impact sensor(s) 20.

The computing device 100 may include one or more processors 102, a non-transitory computer readable medium 104, a communication interface 106, and a user interface 108. Components of the computing device 100 may be linked together by a system bus, network, or other connection mechanism 112.

The one or more processors 102 may be any type of processor(s), such as a microprocessor, a field programmable gate array, a digital signal processor, a multicore processor, etc., coupled to the non-transitory computer readable medium 104.

The non-transitory computer readable medium 104 may be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 may store instructions 114. The instructions 114 may be executable by the one or more processors 102 to cause the computing device 100 to perform any of the functions or methods described herein.

The communication interface 106 may include hardware to enable communication within the computing device 100 and/or between the computing device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 may be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 may be configured to facilitate wired data communication with one or more other devices. The communication interface 106 may also include analog-to-digital converters (ADCs) or digital-to-analog converters (DACs) that the computing device 100 can use to control various components of the computing device 100 or external devices.

The user interface 108 may include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 may include one or more pieces of hardware used to provide data and control signals to the computing device 100. For instance, the user interface 108 can include a mouse or a pointing device, a keyboard or a keypad, a microphone, a touchpad, or a touchscreen, among other possible types of user input devices. Generally, the user interface 108 may enable an operator to interact with a graphical user interface (GUI) provided by the computing device 100 (e.g., displayed by the user interface 108).

The vehicle 10 may be a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone).

The sensor 12A and the sensor 12B may generally take the form of any combination of visible light cameras, infrared cameras, light detection and ranging (LIDAR) transceivers, or radar transceivers having digital image sensors. However, the sensor 12A and the sensor 12B could take other forms such as any other device that detects electromagnetic radiation and generates an image (e.g., an array of pixel values) that characterizes the electromagnetic radiation.

The actuator(s) 14 may include one or more thrusters, propellers, rotors, jet engines, or control surfaces that are configured to cause the vehicle 10 to move or change direction or orientation. In some embodiments, the actuator(s) 14 include components that facilitate movement, including one or more gearboxes that each drive one or more propellers and/or one or more propeller motors. The actuator(s) 14 may also include multiple lift rotors that facilitate vertical takeoff and landing of the aircraft 10. Each lift rotor may be driven by a gearbox, which in turn may be driven by an electric motor. Further, the vehicle 10 may have one or more battery modules and one or more energy management systems (EMSs) that are in communication with the battery modules and that are configured as electronic regulators to monitor and control the charging and discharging of the battery modules.

The structure 16 may be a flexible structure that extends away from the body 18, such as a wing.

The body 18 may be any suitable shape, size, or configuration suitable for the purpose of the vehicle 10. For example, the body 18 may be oval, square, triangular, or otherwise any appropriate shape sufficient to hold cargo and/or passengers while remaining structurally sound. The body 18 may include a fuselage configured to provide structure to connect and/or link a lift surface structure of a lift surface the vehicle 10. In some embodiments, the fuselage may be of truss, monocoque, or semi-monocoque construction. The fuselage may be constructed of any suitable material, such as metal and/or a composite laminate.

The impact sensor(s) 20 may be positioned on opposite sides or ends of the vehicle 10 and can take the form accelerometers that can be used to detect impacts to the vehicle 10 such as bird strikes or collisions with the ground.

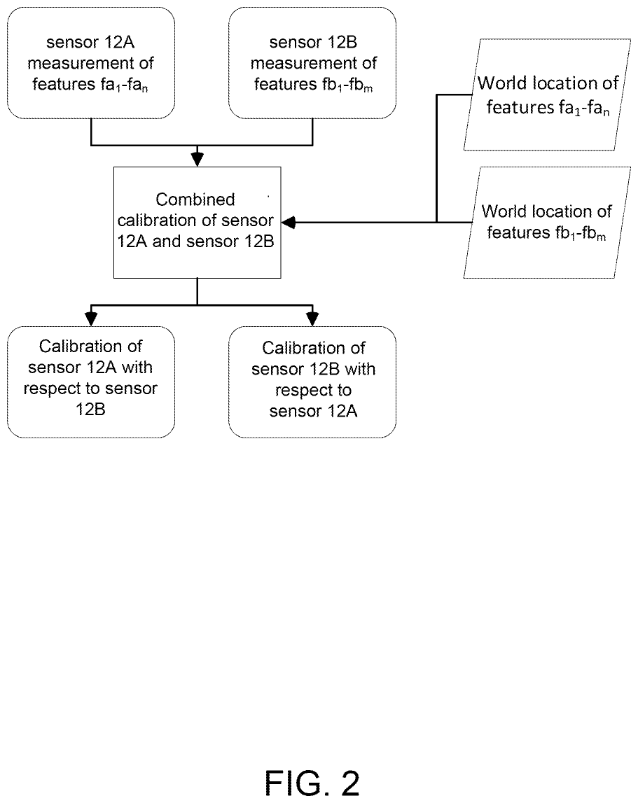

FIG. 2 is a flow chart of functionality of the vehicle 10 that operates within an environment, in accordance with exemplary embodiments of the present invention. In some embodiments, the vehicle 10 may use the sensor 12A to capture a measurement (e.g., an image) that includes one or more one or more first features of the environment, for example, the quantity of ‘n’ features fa₁-faₙ. Additionally, the sensor 12B may capture a measurement (e.g., an image) that includes one or more one or more second features of the environment, for example, the quantity of ‘m’ features fb₁-fbₘ. The vehicle 10 may also access known locations of the features fa₁-faₙ (e.g., world location of features fa₁-faₙ) and known locations of the features fb₁-fbₘ (e.g., world location of features fb₁-fbₘ) and use the known locations to perform a combined calibration of the sensor 12A and the sensor 12B. Subsequently, the vehicle 10 may calibrate the sensor 12A with respect to the sensor 12B and/or calibrate the sensor 12B with respect to the sensor 12A.

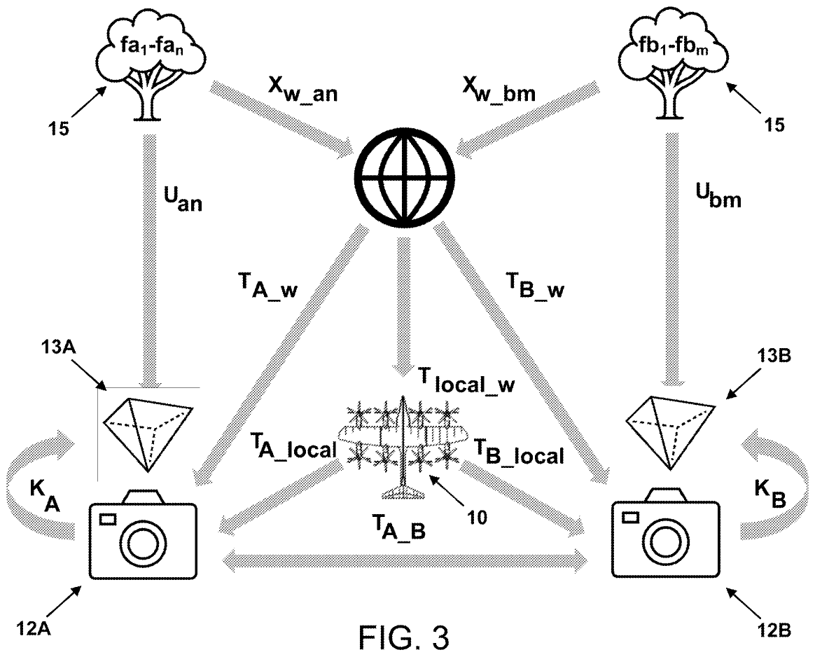

FIG. 3 is a schematic diagram of functionality of the vehicle 10 that operates within an environment 15, in accordance with exemplary embodiments of the present invention. In FIG. 3, the vehicle 10 takes the form of an aerial vehicle. The sensor 12A and the sensor 12B may be mounted to opposite wings of the vehicle 10.

In some embodiments, the vehicle 10 may capture a measurement 13A of the features fa₁-faₙ of the environment 15 using the sensor 12A that is attached to the vehicle 10. Additionally, the vehicle 10 may capture a measurement 13B of the features fb₁-fbₘ of the environment 15 using the sensor 12B that is attached to the vehicle 10. The sensor 12A and the sensor 12B may be attached to opposite wings or otherwise attached to opposite sides (e.g., port/starboard or forward/aft) of the vehicle 10. In some embodiments, the features fa₁-faₙ and/or the features fb₁-fbₘ may include a landing pad or a vertiport, a fiducial maker, a landmark, a tree, or a building. One or more of the features fa₁-faₙ may be included in the features fb₁-fbₘ, or the two sets of features may be completely distinct. The sensor 12A may capture the measurement 13A simultaneously with the sensor 12B capturing the measurement 13B. In some embodiments, the sensor 12A and the sensor 12B may have respective fields of view that overlap. In other embodiments, the respective fields of view might not overlap.

Next, the vehicle 10 may determine a set of parameters comprising one or more of (a) intrinsic parameters KA of the sensor 12A, (b) intrinsic parameters KB of the sensor 12B, or (c) a transform TA B between the sensor 12A and the sensor 12B. The vehicle 10 may determine the set of parameters using the measurement 13A, the measurement 13B, known locations of the features fa₁-faₙ within the environment 15, and known locations of the features fb₁-fbₘ within the environment 15. The vehicle 10 selects an action based on or using the values of the set of parameters and performs the selected action, as discussed in more detail below.

For example, the vehicle 10 may determine a position and/or an orientation of the vehicle 10 within the environment 15 using the set of parameters. More particularly, the set of parameters may be used to interpret future measurements captured by the sensor 12A or the sensor 12B such that the vehicle 10 may more accurately navigate within the environment 15 or avoid objects in the environment 15 shown in the measurements. In this context, selecting the action, such as a locomotive action involving the actuators 14, comprises the vehicle 10 selecting the action based on the position and/or the orientation of the vehicle 10, for example, the position and/or the orientation of the vehicle 10 relative to objects detected within measurements captured by the sensor 12A and/or the sensor 12B. In some embodiments, a locomotive action involving the actuators 14 may include controlling the vehicle 10 to avoid objects in the environment, controlling the vehicle 10 to move away from the position of objects in the environment 15, or controlling the vehicle 10 to move toward from the position of objects in the environment 15. Further, in some embodiments, the action may involve augmenting a map data structure based on information derived using the set of parameters. Moreover, in some embodiments, a determination of a location of the vehicle 10 within the environment 15 may be made using the set of parameters, and the action may involve selecting a control action that moves the vehicle 10 along a predetermined flight path.

In some embodiments, previously known values for intrinsic or extrinsic parameters for the sensor 12A may be considered more reliable than the intrinsic or extrinsic parameters for the sensor 12B. In other embodiments, previously known values for intrinsic or extrinsic parameters for the sensor 12B may be considered more reliable than the parameters for the sensor 12A. For example, an impact to the vehicle 10 such as a bird strike or a hard landing may be sensed closer to one sensor than the other. In this situation, the intrinsic or extrinsic parameters for the sensor farther from the impact might be more reliable.

In some embodiments, the vehicle 10 may determine the intrinsic parameters K_{A} using one or more of (i) the intrinsic parameters K_{B}, (ii) the transform T_{A_B}, (iii) poses of the features fa₁-faₙ within the measurement 13A, (iv) poses of the features fb₁-fbₘ within the measurement 13B, (v) poses of the features fa₁-faₙ within the environment 15, and (vi) poses of the features fb₁-fbₘ within the environment 15. As used herein, a pose may mean a position and/or an orientation within a reference frame such as the environment 15 or the vehicle 10.

For example, the vehicle 10 may use the equation K_{A}=T_{A_B}⁻¹K_{B}UₐₙX_{w_an}⁻¹U_{bm}⁻¹X_{w_bm} to solve for the intrinsic parameters K_{A} of the sensor 12A. Several instances of this equation are typically used to solve for K_{A}, with each equation including different values of Uₐₙ, X_{w_an}, X_{w_bm}, and/or U_{bm} corresponding to different features among the features fa₁-faₙ and the features fb₁-fbₘ.

In some embodiments, TA B is the transform between the sensor 12A and the sensor 12B. Further, in some embodiments, Uₐₙ represents the pose of any one of the features fa₁-faₙ with respect to the sensor 12A as detected within the measurement 13A (e.g., using computer vision techniques), U_{bm} represents the pose of any one of the features fb₁-fbₘ with respect to the sensor 12B as detected within the measurement 13B (e.g., using computer vision techniques), X_{w_an} represents the known poses (e.g., latitude, longitude, altitude, and/or orientation) of any one of the features fa₁-faₙ within the environment 15, and X_{w_bm} represents the known poses (e.g., latitude, longitude, altitude, and/or orientation) of any one of the features fb₁-fbₘ within the environment 15. The intrinsic parameters K_{A} may include a focal length of the sensor 12A, an optical center of the sensor 12A, and/or a skew coefficient of the sensor 12A. The intrinsic parameters K_{B} may include a focal length of the sensor 12B, an optical center of the sensor 12B, and/or a skew coefficient of the sensor 12B. Thus, in situations where the impact sensors 20 detect an impact to the vehicle 10 that is closer to the sensor 12A than the sensor 12B, the vehicle 10 may determine the intrinsic parameters K_{A} in response to detecting the impact.

In other embodiments, the impact sensors 20 may detect an impact to the vehicle 10 that is closer to the sensor 12B than the sensor 12A. As such, the vehicle 10 may responsively determine the intrinsic parameters K_{B} using one or more of (i) the intrinsic parameters K_{A}, (ii) the transform T_{A_B}, (iii) the poses Uₐₙ, (iv) the poses U_{bm}, (v) the poses X_{w_an}, and (vi) the poses X_{w_bm}.

Along these lines, the vehicle 10 may also determine the transform T_{A_B} using one or more of (i) the intrinsic parameters K_{A}, (ii) the intrinsic parameters K_{B}, (iii) the poses Uₐₙ, (iv) the poses U_{bm}, (v) the poses X_{w_an}, and (vi) the poses X_{w_bm}. In some embodiments the vehicle 10 may determine the transform T_{A_B} using direct linear transformation.

In some embodiments, the vehicle 10 may detect an impact to the vehicle 10 that is closer to the sensor 12B than the sensor 12A and determines extrinsic parameters of the sensor 12B using the transform T_{A_B} and extrinsic parameters of the sensor 12A. Thus, the vehicle 10 may operate the sensor 12B according to the extrinsic parameters of the sensor 12B.

In other embodiments, the vehicle 10 detects an impact to the vehicle 10 that is closer to the sensor 12A than the sensor 12B and determines extrinsic parameters of the sensor 12A using the transform T_{A_B} and extrinsic parameters of the sensor 12B. Thus, the vehicle 10 may operate the sensor 12A according to the extrinsic parameters of the sensor 12A.

As noted above, the set of parameters may include one or more of the intrinsic parameters K_{A}, the intrinsic parameters K_{B}, or the transform T_{A_B}. The vehicle 10 may identify a position of an object within the environment 15 using the set of parameters and select the action based on the position of the object within the environment 15. For example, the vehicle 10 may use the set of parameters to interpret measurements captured by the sensor 12A or the sensor 12B. In some embodiments, the vehicle 10 may select a control action that moves that vehicle 10 away from the object or a control action that moves that vehicle 10 toward the object.

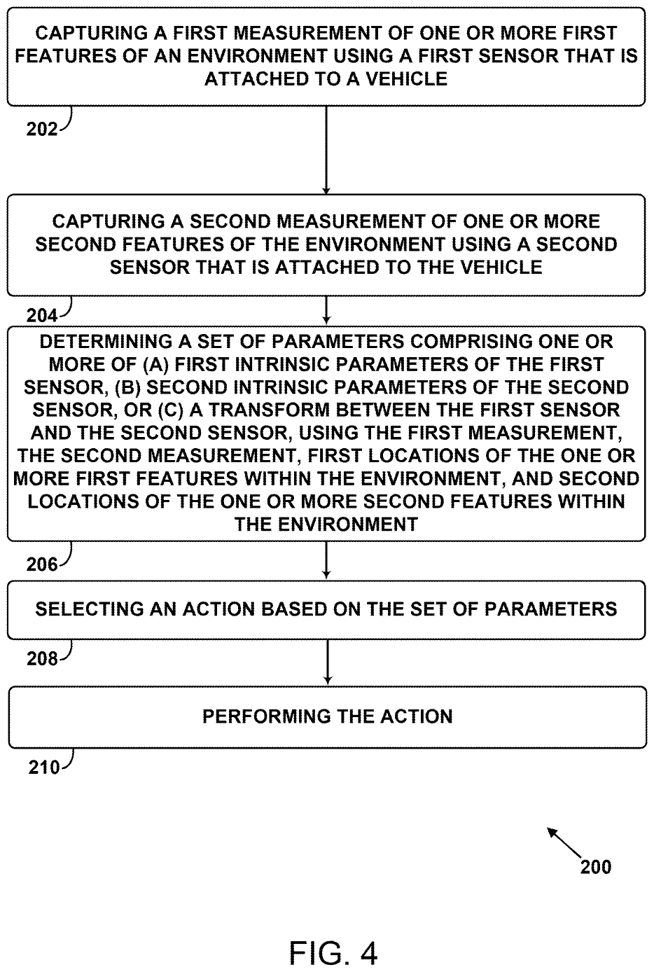

FIG. 4 is a block diagram of a method 200, in accordance with exemplary embodiments of the present invention. The method 200 may be performed by the vehicle 10. As shown in FIG. 4, the method 200 includes one or more operations, functions, or actions as illustrated by steps 202, 204, 206, 208, and 210. Although the steps are illustrated in a sequential order, these steps may also be performed in parallel, and/or in a different order than those described herein. Also, the various steps may be combined into fewer steps, divided into additional steps, and/or removed based upon the desired implementation.

At step 202, the method 200 includes the vehicle 10 capturing the measurement 13A of the features fa₁-faₙ of the environment 15 using the sensor 12A that is attached to the vehicle 10. Functionality related to step 202 is described above with reference to FIG. 3.

At step 204, the method 200 includes the vehicle 10 capturing the measurement 13B of the features fb₁-fbₘ of the environment 15 using the sensor 12B that is attached to the vehicle 10. Functionality related to step 204 is described above with reference to FIG. 3.

At step 206, the method 200 includes the vehicle 10 determining a set of parameters comprising one or more of (a) the intrinsic parameters K_{A}, (b) the intrinsic parameters K_{B}, or (c) the transform T_{A_B}, using the measurement 13A, the measurement 13B, the locations of the features fa₁-faₙ within the environment 15, and locations of the features fb₁-fbₘ within the environment 15. Functionality related to step 206 is described above with reference to FIG. 3.

At step 208, the method 200 includes the vehicle 10 selecting an action based on the set of parameters. Functionality related to step 208 is described above with reference to FIG. 3.

At step 210, the method 200 includes the vehicle 10 performing the action. Functionality related to step 210 is described above with reference to FIG. 3.

### EXAMPLE EMBODIMENTS

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

According to some embodiments, a calibration system may comprise a vehicle comprising a processor, a first sensor attached to the vehicle, and a second sensor attached to the vehicle, wherein the processor determines a first frame of reference for a first sensor based on a first object sensed by the first sensor, wherein the processor determines a second frame of reference for a second sensor based on a second object sensed by the second sensor, wherein the processor determines a transform between the first frame of reference and the second frame of reference, wherein the processor is configured to determine a calibration transform of the first sensor based on the transform.

In some embodiments, the first sensor may be calibrated based on the determined calibration movement. In some embodiments, the transform may be based on a quadratic Renyi entropy minimization. In some embodiments, the first sensor may be configured to measure a distance from the first sensor to the first object. In some embodiments, the processor may determine a position of the first object by comparing a sensed feature to a stored feature. In some embodiments, the first object may be associated with a known local reference frame.

According to some embodiments, a calibration system may comprise a vehicle comprising a processor; a first sensor attached to the vehicle; and a second sensor attached to the vehicle; wherein the processor determines a first frame of reference for a first sensor based on an object sensed by the first sensor; wherein the processor determines a second frame of reference for a second sensor based on the object sensed by the second sensor; wherein the processor determines a transform between the first frame of reference and the second frame of reference; wherein the processor is configured to determine a calibration transform of the first sensor based on the transform.

In some embodiments, the first sensor may be calibrated based on the determined calibration movement. In some embodiments, the transform may be based on a quadratic Renyi entropy minimization. In some embodiments, the first sensor may be configured to measure a distance from the first sensor to the object. In some embodiments, the processor may determine a position of the object by comparing a sensed feature to a stored feature. In some embodiments, the object may be associated with a known local reference frame. In some embodiments, the processor may compare the object to a known local reference frame and determines the object's position based on the known local reference frame.

According to some embodiments, a calibration system may comprise a vehicle comprising a processor; a first sensor attached to the vehicle; and a second sensor attached to the vehicle; wherein the processor receives a geometric location of a calibration object; wherein the processor receives sensor information of the calibration object from the first sensor or the second sensor; wherein the processor determines if the received sensor information can be compared to a stored sensor information based on one or more comparison factors including availability or quality; wherein the processor, after determining it can compare the received sensor information to the stored sensor information, determines a frame of reference of the calibration object based on the comparison.

In some embodiments, the processor may determine a first frame of reference for a first sensor based on an object sensed by the first sensor, determines a second frame of reference for a second sensor based on the object sensed by the second sensor, and determines a transform between the first frame of reference and the second frame of reference. In some embodiments, the processor may be configured to determine a calibration transform of the first sensor based on the transform. In some embodiments, the transform may be based on a quadratic Renyi entropy minimization. In some embodiments, the first sensor may be configured to measure a distance from the first sensor to the calibration object. In some embodiments, the processor may the second sensor may be configured to measure a distance from the first sensor to the calibration object. In some embodiments, the processor may determine at least two comparison factors and ranks the comparison factors based on accuracy of determining the geometric location of the calibration object.

It is to be understood that both the foregoing general description and the following detailed description are exemplary and explanatory only and are not restrictive of the invention. The accompanying drawings, which are incorporated in and constitute a part of this specification, illustrate several exemplary embodiments and together with the description, serve to outline principles of the exemplary embodiments.

Reference will now be made in detail to exemplary embodiments shown in the accompanying drawings.

Exemplary disclosed embodiments include systems, methods, and devices for calibrating a sensor. For example, in some embodiments, a calibration system may include a processor. As used herein, processor may refer to a central processing unit or any other machine that processes something. Some non-limiting examples may include a microprocessor, a microcontroller, or an embedded processor.

Consistent with disclosed embodiments, the calibration system may be configured to include a vehicle. The vehicle may be a ground, sea, or a flying craft. As used herein, a flying craft may refer to an aerial, floating, soaring, hovering, airborne, aeronautical aircraft, airplane, plane, spacecraft, vessel, or other vehicle moving or able to move through air. Some non-limiting examples may include a helicopter, an airship, a hot air balloon, an unmanned aerial vehicle, a VTOL craft, or a drone. For example, the calibration system may be configured to include a processor (e.g., a microprocessor) and one or more sensors of a flying craft (e.g., a helicopter). The vehicle may be autonomous, remotely piloted, or manned. Benefits of disclosed calibration systems may be of use to VTOL craft that rely on sensors for precision movements around buildings or other structures and where the sensors may become non-calibrated due to jostling, landing, or the like. Furthermore, VTOL craft may use frequently-traveled routes to known landing pads or areas or VTOL craft may land in less frequently-traveled routes for example when making a delivery, when acting as a taxi, or similar. Thus, it is useful for VTOL craft to be calibrated at any time, whether in the ground or in the air, based on downloadable or stored information about a surrounding environment including sensed objects in the environment.

Exemplary embodiments disclosed herein include a calibration system to perform target-free calibration when usual calibration techniques are unavailable, such as in-flight or while traveling, after a sensor becomes uncalibrated and thus inaccurate and unreliable. Target calibration systems, methods, and devices proposed herein use, for example, the existing environment near a landing pad or area such as objects including one or more of visual fiducial markings, landmarks, corners of a building or buildings, which are known and present for certain landing locations using special marking and/or landmarks.

A visual fiducial marker can comprise a known shape usually located in the environment as a point of reference and scale for a visual task. Fiducial markers can offer a highly distinguishable pattern with strong visual characteristics that also feature specific encoding as a fail-safe against misdetections. Fiducial markers can include artificial landmarks of known size and shape that feature a specific pattern that is used to identify them. While in most cases the markers are black and white, there are some packages that use colored markers. The landing point is defined using a marker that can be detected by a downward looking camera in the VTOL and further tracked for landing. Complex fiducial markers allow the extraction of more information, for example, full 3D pose and identification of the marker between a large library of possible markers. Additionally, the number of features used for pose calculation can improve the accuracy of the calculated pose.

While the fiducial markers presented above are expected to be detected using visible spectrum cameras for visual operation (e.g., using visual flight rules (“VFR”)), for low lighting (e.g., night, dawn, dusk) or inclement weather conditions infrared (“IR”) cameras in northwest infrared (“NWIR”)/long-wave infrared (“LWI”) spectrum can be used. Fiducial markers can be sensed in low lighting conditions with optical coatings. For example, optical coatings may be produced using plasma-enhanced chemical vapor deposition, ion assist deposition with electron beam sputtering and resistance sources. Fiducial markers may include chalcogenide compounds including at least one chalcogen anion. Fiducial markers may perform over multispectral bands from the visible spectrum (“VIS”) to the LWIR. Fiducial markers may include a chalcogenide coating and be used at one or more of touch-down and lift-off (“TLOF”) and final approach and take-off (“FATO”) areas or surrounding areas.

Fiducial marking can have complex shape and can depend on various design parameters such as the size, number, and arrangement of the fiducial markers, as well as the colors used for “dark” and “light” squares. High-contrast edges make fiducial markers easy to detect in single images. As an example, square grid cells guarantee robustness to changes in orientation (i.e., in the angle at which the fiducial marker is viewed). A unique error-correcting bitcode can provide a fail-safe against misdetections. The unique error-correcting bitcode may be sensed by an approaching aircraft by one or more sensors. While nesting guarantees that similar performance is obtained at long-range (using the large outer marker), medium-range (using the smaller singly-nested marker), and short-range (using the smallest doubly-nested marker).

Extrinsic calibration within the disclosed calibration system may be achieved by sensing one or more objects in an area around a vehicle. The extrinsic calibration may include estimating the rigid-body transformation between the reference coordinate system of the multiple sensors. In the literature there are many calibration algorithms based on correspondences matching. Calibration parameters can be estimated by minimizing a reprojection error and often the accuracy of these methods is dependent upon the accuracy of the established correspondences. An entropy minimization technique can be used such as a quadratic Renyi entropy minimization that can generalize to various sensor combinations. Disclosed methods of calibration provide benefits of more accurate localization for example, to determine a location of a vehicle, to determine a location of a landing area, to determine a location of another vehicle, to determine a location of an obstacle, or similar.

One way that sensors may be calibrated is through localization. Accurate localization can be used for the autonomous navigation of Vertical Take off and Landing (“VTOL”) aircraft in landing and takeoff situations. Accurate localization will be based on accurate adjustment of external calibration parameters and internal calibration parameters. Vision-based navigation that uses multiple cameras to recognize unique markers at the vertiport or landing area level, fused with inertial measurements, is a good candidate for the primary horizontal and vertical navigation system during vertical takeoff to hover and hover to landing. eVTOLs or VTOLs may be piloted on-board or remotely or autonomously. Lighting is required for vertiports that support night or poor weather operations. For pilot-on-board VTOLs lighting can be improved to enable the pilot to both establish the location of the vertiport and identify the perimeter of the operational area. For autonomous or remotely-controlled VTOLs, the lighting can be improved to help with the localization of the aircraft relative to the vertiport. Fiducial markers may be used to achieve such improvements.

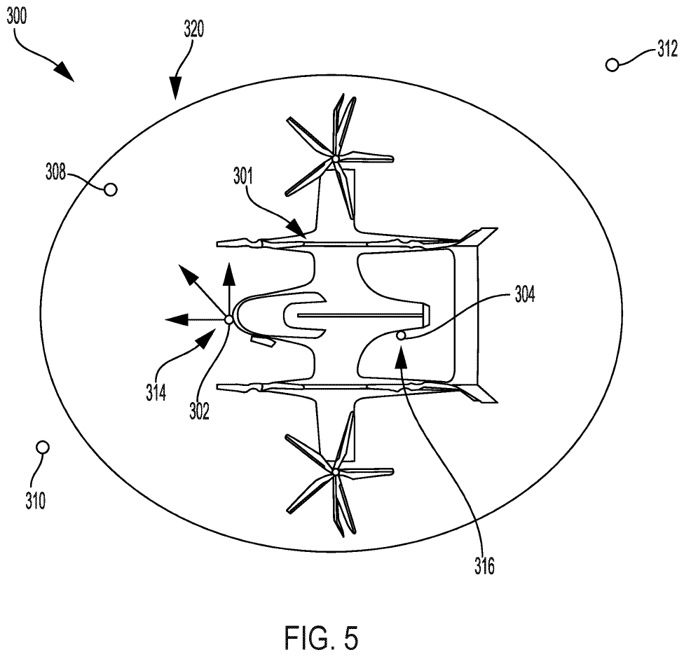

FIG. 5 shows an exemplary system 300 for calibrating a sensor, in accordance with exemplary embodiments of the present invention. Exemplary system 300 may include a processor (not shown), a vehicle 301, a first sensor 302 attached to the vehicle 301, and a second sensor 304 attached to the vehicle 301. As used herein, the word “sensor” is not intended to be limited to a specific type of sensor, and rather could be a reference to any type of sensor known to those skilled in the art, including but not limited to a detector or device which detects or measures a physical property of a system or object and records, indicates, or otherwise responds to it, a camera, a radar, a lidar, a temperature sensor, a proximity sensor, an infrared sensor, a light sensor, an ultrasonic sensor, a position sensor, a force sensor, a vibration sensor, and an imaging sensor. As an example, system 300 may be configured with the first sensor 302 (e.g., an imaging sensor) attached to the flying vehicle 301 (e.g., a helicopter) and the second sensor 304 (e.g., an imaging sensor) attached to the flying vehicle 301 as illustrated by FIG. 5. Sensors 302, 304 may be mounted anywhere along vehicle 301. Although system 300 describes first sensor 302 and the second sensor 304, a plurality of sensors of flying vehicle 301 may be calibrated consistent with the discussion herein.

Exemplary system 300 may comprise one or more of a first object 308, a second object 310, and a third object 312. Exemplary system 300 may be implemented in an area around the vehicle 301 of any suitable size volume, as a person of ordinary skill in the art will understand. For example, area 320 may be an environment around a vehicle including a landing pad, a landing zone, a parking facility, or an area around where the vehicle is for example, during travel or approaching or taking off. One or more objects 308, 310, 312, may be inside of the area or outside of the area. For example, object 308 may be a part of a landing pad of area 320. Object 308 may be a fiducial marker on the landing pad. Object 308 may be a fiducial marker near a landing pad. As another example, objects 310 and/or 312 may be a building outside of area 320. As a further example, objects 310 and/or 312 may be a fiducial marker inside or outside of area 320 on a structure such as a building, a tower, or a wall.

First sensor 302 may be disposed near or at a first end of flying vehicle 301. For example, first sensor 302 may be attached to a nose of flying vehicle 301 or to a cockpit of flying vehicle 301. The second sensor 304 may be disposed near or at a second end of the flying craft. For example, second sensor 304 may be attached to a tail portion of flying vehicle 301. As another example, first sensor 302 may be disposed on one wing and a second sensor 304 may be disposed on another wing.

Exemplary system 300 may comprise sensing a first object 308 or features of first object 308 by one or more of the first and second sensors 302, 304. Sensed information may include an edge (e.g., vertical or horizontal edges of a building), a fiducial marker, a bounding box, a size or orientation of a feature such as a window or a door, a shape, a contrast of one feature compared to another feature, a comparison of the building and its surrounding, an associated beacon or signal, or another distinguishing feature of a building as would be known to one of ordinary skill in the art).

Information may be known about object 308 such as one or more of a global position, a height, a relationship between object 308 and another object, a relative position in one or more directions of vehicle 301 relative to object 308, a bitcode associated with object 308 to ensure it is the correct object, a position of object 308 on a 2D or a 3D feature map, a position of object 308 on a depth map, a position of object 308 on a disparity map, a position of object 308 on an optical flow map, or a position of object 308 on a 3D point cloud. Information of objects 310, 312 may be similarly known. Information may be stored on memory onboard vehicle 301 or on a memory accessible by vehicle 301, for example, through a cloud computing environment or a wireless communication. In some embodiments, information about one or more objects 308, 310, 312 can be checked via a database associated with one or more bitcodes, or based on any information above relative to a position of vehicle 301 or from one object 308 to another object 310 (e.g., a distance between two known objects, a relative height of one object compared to another object, or similar).

In some embodiments, object 308 may comprise a fiducial marking. In some embodiments, object 308 may comprise an optical coating.

In some embodiments, first and second sensors 302, 304, may sense the same object 308 to calibrate one or more of first and second sensors 302, 304. In some embodiments, first and second sensors 302, 304 may sense different objects, such as object 308 for first sensor 302 and object 310 by second sensor 304.

First and second sensors 302, 304 may determine a position and/or orientation of each of first and second sensors 302, 304 based on a comparison of sensed one or more objects 308, 310, and 312 and known information of one or more objects 308, 310, and 312. A processor associated with vehicle 301, either within vehicle 301 or in communication with vehicle 301, may determine a transform between first and second sensors 302, 304 based on the comparison. A transform or transformation may reflect one or more of a rotational matrix and/or a translation matrix between two reference points and/or reference frames. Scaling may be used to match one reference system (e.g., of a map) to another reference system (e.g., of a sensor). Scaling may be performed based on a determined positioning system such as a global positioning system, and/or by using speed and/or inertial sensor. A mechanical movement may accomplish calibration of sensors 302, 304, for example, through a mount or a sensor adjustment accomplished by an actuator. A digital transformation may be used to accomplish calibration of sensors 302, 304.

In some embodiments, at least one of the first known object, the second known object, and the third known object may be disposed at a relative ground level. As disclosed herein, a relative ground level or TLOF may refer to a relative altitude of a landing pad or area or an area surrounding the landing pad or area. For example, many runways or helipads are known to be at an elevation above mean sea level. In some embodiments, at least one of the first known object, the second known object, and the third known object may be associated with a known local reference frame. For example, a processor may be able to retrace the known local reference frame associated with one or more of the first known object, the second known object, and third known object.

In some embodiments, the first known objection may be at a known height above or below the second known object or the third known object.

System 300 may be configured with a first frame of reference 314 determined by a first sensor 302 or a processor associated with first sensor 302 by making determinations based on one or more of a first object 308, a second object 310, and a third object 312 and one or more sensed features associated with objects 308, 310, 312. System 300 may be configured with a second frame of reference 316 determined by a second sensor 304 or a processor associated with second sensor 304 by making determinations based on one or more of a first object 308, a second object 310, and a third object 312 and one or more sensed features associated with objects 308, 310, 312. One or more processors associated with vehicle 301 may determine a transform between first frame of reference 314 and second frame of reference 316 to determine a position, orientation, and/or a calibration movement to calibrate first sensor 302 or second sensor 304. One or more objects 308, 310, and 312 may be used to check the determined position, orientation, and/or calibration movement.

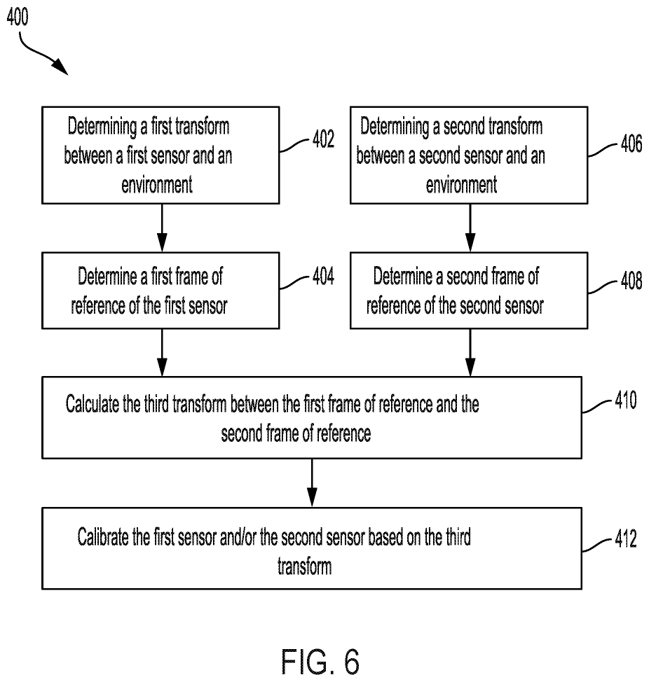

FIG. 6 shows an exemplary method 400 of sensor calibration, in accordance with exemplary embodiments of the present invention. Method 400 may comprise steps that can be performed by one or more processors located on a vehicle. As shown at step 402, method 400 may include determining a first transform between a first sensor and an environment. Method 400 may include step 404 including determining a second transform between a second sensor and an environment. The environment in steps 404, 406 may be indicated by information about one or more objects (e.g., objects 308, 310, 312). Information may be known or retrieved about one or more objects as discussed above with reference to FIG. 5. The processor may compare the known information with sensed information from one or more of first and second sensors. For example, a known height of an object may be compared with a sensed height of the object. As another example, a known disparity map, 2D map, or 3D map, each including an object, may be compared with the determined disparity map, 2D map, or 3D map, each including the object. The first and second transforms may be found based on the known position of the one or more objects and one or more sensed features of the one or more objects. In some embodiments, an object frame of reference may be determined for one or more objects, and the object frame of reference and one or more sensed features of the one or more objects may be used to determine the first and/or second transforms of the first and/or second sensors respectively.

Method 400 may include step 404 wherein the processor determines a first frame of reference of the first sensor. The first frame of reference may be determined based on a current position and/or orientation of the first sensor. Method 400 may include step 408 wherein the processor determines a second frame of reference of the second sensor. The second frame of reference may be determined based on a current position and/or orientation of the second sensor. The first and second frames of reference may change during or as a result of a vehicle's movement, such when the vehicle is jostled, strikes a surface, or similar. The first and second frames of reference may be based on an aircraft position and/or orientation. The vehicle position and/or orientation may be determined from a global positioning system, from one or more sensors such as an altimeter, an antenna array, a radio navigation aid, a turn coordinator, a speedometer, a position of a light source such as a sun or a moon, a position of a beacon, or as could be determined by one of ordinary skill in the art with one or more instruments of the vehicle.

Method 400 may include step 410 including determining a transform (e.g., a rotation of 0.5° around an axis) between the first sensor and the second sensor based on the difference of the first frame of reference relative to the second frame of reference. In some embodiments, determining the third transform, may be based on entropy minimization technique such as a quadratic Renyi entropy minimization.

Method 400 may include step 412 including calibrating the sensors'frame of reference orientations based on the third transform between the first sensor and the second sensor. Some non-limiting examples of calibrations may include a rotation and/or a translation. For example, a processor (e.g., a microprocessor) may be configured to send instructions for calibrating (e.g., a rotation of 0.1°, 0.5°, or 1°) the first and second sensors.

In some embodiments, when a third transform is calculated that exceeds a threshold amount that can be corrected through calibration, an error can be sent to one or more display devices of vehicle 301 or wirelessly communicated to an operating or monitoring system. The error may alert an operator or monitor that one or more sensors cannot be calibrated. In some embodiments, the operator or monitor may determine to avoid an instrument-based or precision approach or vehicle movement that relies on one or more of the non-calibrated sensors.

According to another embodiment of the present disclosure, a non-transitory computer readable medium comprising instructions to perform steps for calibrating one or more sensors may be provided. As used herein, non-transitory computer readable medium refers to any type of physical memory on which information or data readable by at least one processor can be stored. Some non-limiting examples may include Random Access Memory, Read-Only Memory, hard drives, or any other optical data storage medium and other similar memory.

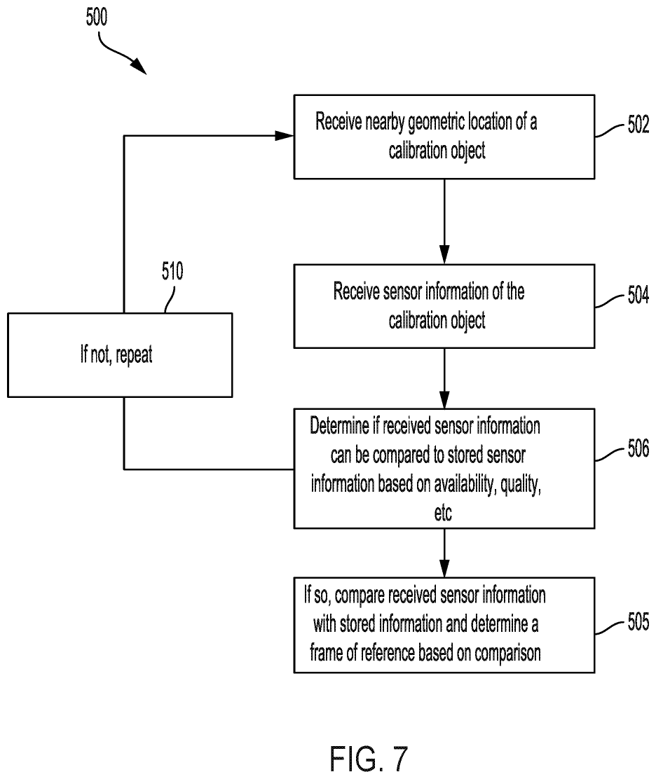

FIG. 7 shows an exemplary method of environment detection, in accordance with exemplary embodiments of the present invention. Method 500 may be performed by a processor. Method 500 may include step 502 including receiving a nearby geometric location of a calibration object. The calibration object may be similar to objects 308, 310, or 312 described with reference to FIG. 5. The geometric location may be determined by one or more sensors or received from a communication system. One or more sensors may sense the calibration object when a vehicle is in a defined vicinity of the calibration object. One or more manned or autonomous systems may send geometric location of a calibration object to the vehicle when the vehicle is within a defined vicinity of the calibration object. Once determined or received, one or more processors associated with the vehicle alone or as commanded by an operator, may determine to perform a calibration.

Method 500 may include step 504 including receiving sensor information of the calibration object. Sensor information may be in a form as described with reference to FIG. 5.

Method 500 may include step 506 including determining if the received sensor information of the calibration object can be compared with a stored sensor information. The determination may be based on availability of stored sensor information for the calibration object, the quality of stored information for the calibration object alone or when compared to the quality of received sensor information, the position of the vehicle (e.g., if the vehicle is in a known area where better calibration objects for example with higher fidelity information are present or if the vehicle is in an unknown area where calibration objects for example with lesser fidelity information are present),

Method 500 may include step 508 including, if the answer to step 506 is yes, comparing received sensor information of the calibrated object with stored information. Step 508 may include determining a frame of reference, for example, for a sensor, based on the comparison.

Method 500 may include step 510 including, if the answer to step 506 is no, repeating step 502 until an appropriate calibration object is selected. The relative appropriateness of the calibration object determination may be based on availability of stored sensor information for the calibration object, the quality of stored information for the calibration object alone or when compared to the quality of received sensor information, the position of the vehicle (e.g., if the vehicle is in a known area where better calibration objects for example with higher fidelity information are present or if the vehicle is in an unknown area where calibration objects for example with lesser fidelity information are present), or similar, In some embodiments, the one or more processors associated with method 500 may include a machine learning algorithm to order calibration targets based on previous successful calibrations in order of calibration successes receiving for example a high preference grade to calibration failures receiving for example a low preference grade. Grades may be based on any of the parameters regarding quality of received information or stored information as discussed above or with reference to a vehicle's position relative to the calibrated object (e.g., further away from the calibrated object may be associated with a lower grade while closer may be associated with a higher grade).

Although multiple steps are disclosed with reference to methods 500 and 500, it is contemplated that one or more steps may be omitted, added, combined, separated, or re-arranged in a different order if required information is available.

It will be apparent to those skilled in the art that various modifications and variations can be made to the disclosed flying craft, processes for determining a location of an object or a transformation, processors, and sensors. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

Implementations of the present disclosure can thus relate to one of the enumerated example embodiments (EEEs) listed below.
EEE 1 is a calibration system comprising: a vehicle comprising a processor; a first sensor attached to the vehicle; and a second sensor attached to the vehicle; wherein the processor determines a first frame of reference for a first sensor based on a first object sensed by the first sensor; wherein the processor determines a second frame of reference for a second sensor based on a second object sensed by the second sensor; wherein the processor determines a transform between the first frame of reference and the second frame of reference; wherein the processor is configured to determine a calibration transform of the first sensor based on the transform.
EEE 2 is the calibration system of EEE 1, wherein the first sensor calibrates based on the determined calibration movement.
EEE 3 is the calibration system of EEE 1, wherein the transform is based on a quadratic Renyi entropy minimization.
EEE 4 is the calibration system of EEE 1, wherein the first sensor is configured to measure a distance from the first sensor to the first object.
EEE 5 is the calibration system of EEE 1, wherein the processor determines a position of the first object by comparing a sensed feature to a stored feature.
EEE 6 is the calibration system of EEE 1, wherein the first object is associated with a known local reference frame.
EEE 7 is a calibration system comprising: a vehicle comprising a processor; a first sensor attached to the vehicle; and a second sensor attached to the vehicle; wherein the processor determines a first frame of reference for a first sensor based on an object sensed by the first sensor; wherein the processor determines a second frame of reference for a second sensor based on the object sensed by the second sensor; wherein the processor determines a transform between the first frame of reference and the second frame of reference; wherein the processor is configured to determine a calibration transform of the first sensor based on the transform.
EEE 8 is a calibration system of EEE 7, wherein the first sensor is calibrated based on the determined calibration movement.
EEE 9 is the calibration system of EEE 7, wherein the transform is based on a quadratic Renyi entropy minimization.
EEE 10 is the calibration system of EEE 7, wherein the first sensor is configured to measure a distance from the first sensor to the object.
EEE 11 is the calibration system of EEE 7, wherein the processor determines a position of the object by comparing a sensed feature to a stored feature.
EEE 12 is the calibration system of EEE 7, wherein the object is associated with a known local reference frame.
EEE 13 is the calibration system of EEE 7, wherein the processor compares the object to a known local reference frame and determines the object's position based on the known local reference frame.
EEE 14 is a calibration system comprising: a vehicle comprising a processor; a first sensor attached to the vehicle; and a second sensor attached to the vehicle; wherein the processor receives a geometric location of a calibration object; wherein the processor receives sensor information of the calibration object from the first sensor or the second sensor; wherein the processor determines if the received sensor information can be compared to a stored sensor information based on one or more comparison factors including availability or quality; wherein the processor, after determining it can compare the received sensor information to the stored sensor information, determines a frame of reference of the calibration object based on the comparison.
EEE 15 is the calibration system of embodiment 14, wherein the processor determines a first frame of reference for a first sensor based on an object sensed by the first sensor, determines a second frame of reference for a second sensor based on the object sensed by the second sensor, and determines a transform between the first frame of reference and the second frame of reference.
EEE 16 is the calibration system of EEE 15, wherein processor is configured to determine a calibration transform of the first sensor based on the transform.
EEE 17 is the calibration system of EEE 15, wherein the transform is based on a quadratic Renyi entropy minimization.
EEE 18 is the calibration system of EEE 14, wherein the first sensor is configured to measure a distance from the first sensor to the calibration object.
EEE 19 is the calibration system of EEE 14, wherein the second sensor is configured to measure a distance from the first sensor to the calibration object.
EEE 20 is the calibration system of EEE 14, wherein the processor determines at least two comparison factors and ranks the comparison factors based on accuracy of determining the geometric location of the calibration object.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

1. A method comprising:
capturing a first measurement of one or more first features of an environment using a first sensor that is attached to a vehicle;
capturing a second measurement of one or more second features of the environment using a second sensor that is attached to the vehicle;
determining a set of parameters comprising one or more of (a) first intrinsic parameters of the first sensor, (b) second intrinsic parameters of the second sensor, or (c) a transform between the first sensor and the second sensor, using the first measurement, the second measurement, first locations of the one or more first features within the environment, and second locations of the one or more second features within the environment;
selecting an action based on the set of parameters; and
performing the action.

2-3. (canceled)

4. The method of claim 1, wherein the one or more first features or the one or more second features comprise a landing pad, a fiducial maker, a landmark, a tree, or a building.

5. (canceled)

6. The method of claim 1, further comprising determining a position and/or an orientation of the vehicle within the environment using the set of parameters, wherein selecting the action comprises selecting the action based on the position and/or the orientation.

7. The method of claim 1, wherein capturing the second measurement comprises capturing the second measurement simultaneously with capturing the first measurement.

8-9. (canceled)

10. The method of claim 1, wherein determining the set of parameters comprises determining the first intrinsic parameters using one or more of (i) the second intrinsic parameters, (ii) the transform, (iii) poses of the one or more first features within the first measurement, (iv) poses of the one or more second features within the second measurement, (v) poses of the one or more first features within the environment, and (vi) poses of the one or more second features within the environment.

11. The method of claim 10, wherein determining the first intrinsic parameters comprises determining a focal length of the first sensor, an optical center of the first sensor, or a skew coefficient of the first sensor.

12. The method of claim 10, further comprising detecting an impact to the vehicle that is closer to the first sensor than the second sensor, wherein determining the first intrinsic parameters comprises determining the first intrinsic parameters in response to detecting the impact.

13. The method of claim 1, wherein determining the set of parameters comprises determining the second intrinsic parameters using one or more of (i) the first intrinsic parameters, (ii) the transform, (iii) poses of the one or more first features within the first measurement, (iv) poses of the one or more second features within the second measurement, (v) poses of the one or more first features within the environment, and (vi) poses of the one or more second features within the environment.

14. The method of claim 13, wherein determining the second intrinsic parameters comprises determining a focal length of the second sensor, an optical center of the second sensor, or a skew coefficient of the second sensor.

15. The method of claim 13, further comprising detecting an impact to the vehicle that is closer to the second sensor than the first sensor, wherein determining the second intrinsic parameters comprises determining the second intrinsic parameters in response to detecting the impact.

16. The method of claim 1, wherein determining the set of parameters comprises determining the transform using one or more of (i) the first intrinsic parameters, (ii) the second intrinsic parameters, (iii) poses of the one or more first features within the first measurement, (iv) poses of the one or more second features within the second measurement, (v) poses of the one or more first features within the environment, and (vi) poses of the one or more second features within the environment.

17. (canceled)

18. The method of claim 16, further comprising:
detecting an impact to the vehicle that is closer to the second sensor than the first sensor;
determining second extrinsic parameters of the second sensor using the transform and first extrinsic parameters of the first sensor; and
operating the second sensor according to the second extrinsic parameters.

19. The method of claim 16, further comprising:
detecting an impact to the vehicle that is closer to the first sensor than the second sensor;
determining first extrinsic parameters of the first sensor using the transform and second extrinsic parameters of the second sensor; and operating the first sensor according to the first extrinsic parameters.

20. The method of claim 1, further comprising identifying a position of an object within the environment using the set of parameters, wherein selecting the action comprises selecting the action based on the position of the object within the environment.

21-22. (canceled)

23. The method of claim 20, wherein selecting the action comprises augmenting a map data structure based on information derived using the set of parameters.

24. The method of claim 20, further comprising determining a location of the vehicle within the environment using the set of parameters, wherein selecting the action comprises selecting a control action that moves the vehicle along a predetermined flight path.

25-26. (canceled)

27. The method of claim 1, wherein the first sensor comprises a visible light camera, an infrared camera, a radar transceiver, or a light detection and ranging (LIDAR) transceiver.

28-30. (canceled)

31. The method of claim 1, wherein the second sensor comprises a visible light camera, an infrared camera, a radar transceiver, or a light detection and ranging (LIDAR) transceiver.

32-34. (canceled)

35. A non-transitory computer readable medium storing instructions that, when executed by one or more processors of a vehicle, cause the vehicle to perform functions comprising:
capturing a first measurement of one or more first features of an environment using a first sensor that is attached to a vehicle;
capturing a second measurement of one or more second features of the environment using a second sensor that is attached to the vehicle;
determining a set of parameters comprising one or more of (a) first intrinsic parameters of the first sensor, (b) second intrinsic parameters of the second sensor, or (c) a transform between the first sensor and the second sensor, using the first measurement, the second measurement, first locations of the one or more first features within the environment, and second locations of the one or more second features within the environment;
selecting an action based on the set of parameters; and
performing the action.

36. A vehicle comprising:
a first sensor;
a second sensor;
one or more processors; and
a computer readable medium storing instructions that, when executed by the one or more processors, cause the vehicle to perform functions comprising:
capturing a first measurement of one or more first features of an environment using the first sensor that is attached to a vehicle;
capturing a second measurement of one or more second features of the environment using the second sensor that is attached to the vehicle;
determining a set of parameters comprising one or more of (a) first intrinsic parameters of the first sensor, (b) second intrinsic parameters of the second sensor, or (c) a transform between the first sensor and the second sensor, using the first measurement, the second measurement, first locations of the one or more first features within the environment, and second locations of the one or more second features within the environment;
selecting an action based on the set of parameters; and
performing the action.

37-62. (canceled)
